(19) United States
(12) Patent Application Publication
(10) Pub. No.: US 2011/0072478 A1
(43) Pub. Date: Mar. 24, 2011

(54) BANDWIDTH REPORTING FOR TELEVISIONS

(75) Inventors: Abhishek Patil, San Diego, CA (US); Xiangpeng Jing, San Diego, CA (US); Djung Nguyen, San Diego, CA (US); Ling Jun Wong, Escondido, CA (US); Dipendu Saha, San Diego, CA (US); Nobukazu Sugiyama, San Diego, CA (US)

(73) Assignees: SONY CORPORATION, Tokyo (JP); SONY ELECTRONICS, Parkridge, NJ (US)

(21) Appl. No.: 12/566,483

(22) Filed: Sep. 24, 2009

(51) Int. Cl. H04N 7/173; G06F 3/00; H04J 1/16

(52) U.S. Cl. 725/110; 715/719; 370/252

(57) ABSTRACT

Techniques for reporting bandwidth in televisions include displaying bandwidth information for receiving one or more instances of the content and receiving a selection of a given instance of the content in response to the displayed bandwidth information. In addition, the techniques include receiving bandwidth usage history for one or more networks and displaying the bandwidth usage history.

### BACKGROUND OF THE INVENTION

Internet enabled televisions (TV) open doors to a lot of opportunities and issues that were absent in traditional TVs. With web-enabled TVs, users have more choices to entertain themselves. For example, they can watch a variety online video streams or view photos shared by friends and family. Video streaming, especially high definition video streams, is bandwidth intensive. In some cases, internet usage is billed based upon the bandwidth used. In certain situations, there may be a limit on the bandwidth usage and/or hefty overage charges. Therefore, there is a continuing need for monitoring bandwidth usage when viewing content on an internet enabled TV.

### SUMMARY OF THE INVENTION

Embodiments of the present technology are directed toward bandwidth reporting techniques for use in televisions. In one embodiment, a network-enabled TV receives and displays bandwidth information regarding content on one or more networks. The TV may then receive a selection of a given instance of a given content in response to the displayed bandwidth information. In response to the selection, the TV sends a request for the given instance of the given content and thereafter receives and displays the requested given instance of the given content.

In another embodiment, the TV determines if one or more networks have bandwidth restrictions. If one or more networks have bandwidth restrictions, the TV receives and displays the bandwidth usage history for each of the networks having bandwidth restrictions.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 shows a block diagram of a television system, in accordance with one embodiment of the present technology.

FIG. 2 shows a flow diagram of a method of bandwidth based selection of content, in accordance with one embodiment of the present technology.

FIG. 3 shows a block diagram of an exemplary graphical user interface, in accordance with one embodiment of the present technology.

FIG. 4 shows a flow diagram of a method of reporting bandwidth usage, in accordance with another embodiment of the present technology.

FIG. 5 shows a block diagram of an exemplary graphical user interface, in accordance with another embodiment of the present technology.

FIG. 6 shows a block diagram of a method of creating a user profile for bandwidth based selection of content and/or bandwidth usage reporting, in accordance with another embodiment of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the invention to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

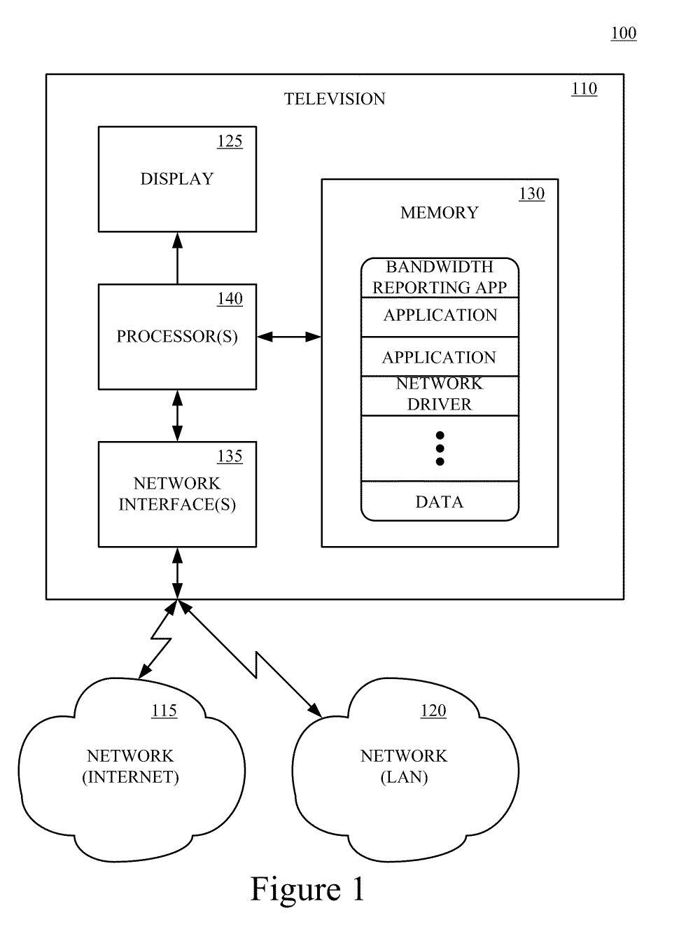

FIG. 1 shows a television system, in accordance with one embodiment of the present technology. The system includes a television 110 communicatively coupled to one or more networks 115, 120. The networks may include the internet (e.g., World Wide Web), one or more local area networks (e.g., home networks), one or more wide area networks, broadcast networks, and/or the like. The television 110 includes, but is not limited to, a display (e.g., liquid crystal display panel, plasma panel, cathode ray tube) 125, one or more computing device readable media (e.g., memory) 130, and one or more network interfaces (e.g., set top box, modem, Ethernet card) 135 communicatively coupled to one or more computing devices (e.g., central processing unit, microcontroller, digital signal processor) 140.

The one or more computing device readable media 130 provides for storage of computing device executable instructions and data. The data may be arranged in or more data structures. The computing device executable instructions when executed by the computing device 140 implements one or more applications, routines, utilities, drivers, widgets and the like. The one or more applications, routines, utilities, drivers, widgets and the like include a bandwidth reporting application, one or more network drivers, and one or more applications that consume bandwidth on the one or more networks by sending and/or receiving content, instructions, data and the like on the one or more networks.

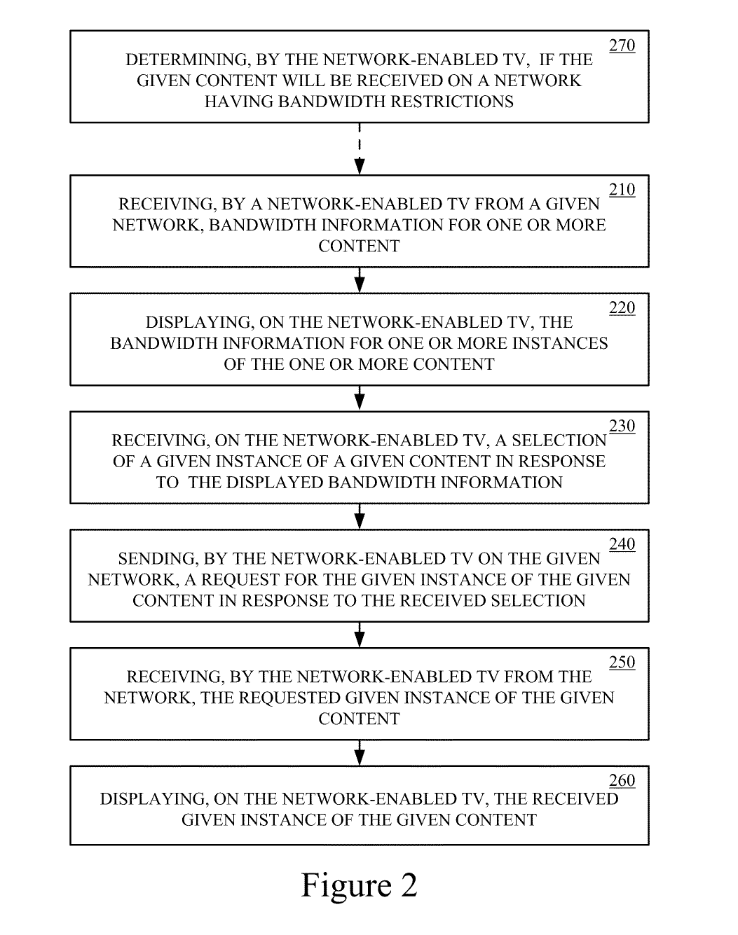

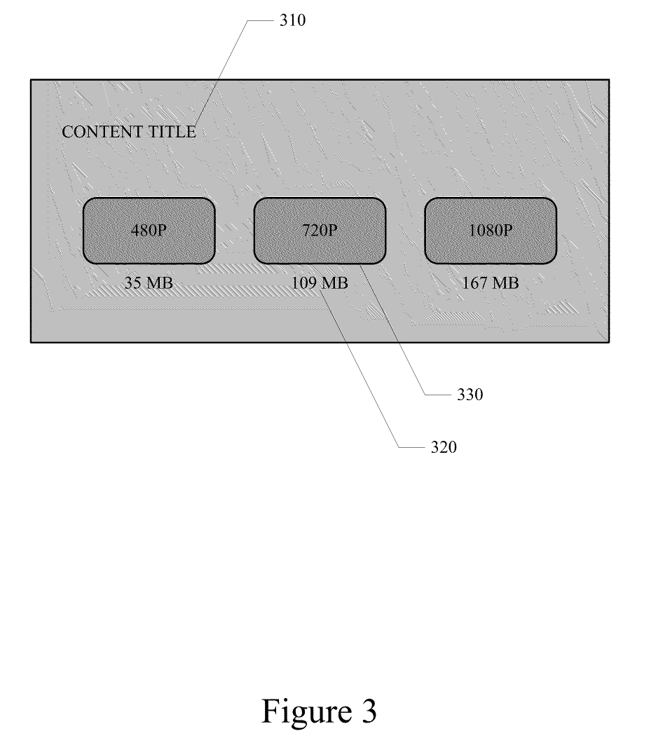

Operation of the television system 100 will be further explained with reference to FIGS. 2-6. Referring now to FIG. 2, a method of bandwidth based selection of content, in accordance with one embodiment of the present technology, is shown. At 210, bandwidth information concerning one or more content is received by the network-enabled TV 110. In one implementation, the bandwidth reporting application receives metadata indicating the bandwidth required to receive content such as video or pictures from the internet. At 220, the bandwidth information for one or more instances of the one or more content is displayed on the network-enabled TV. In one implementation, the bandwidth reporting application generates a graphical user interface including bandwidth requirements for the content in one or more transmission modes. If available, the bandwidth reporting application may be able to provide multiple choices for a given video with different quality/bandwidth characteristics. Referring now to FIG. 3, an exemplary graphical user interface, in accordance with one embodiment of the present technology, is shown. The graphical user interface may identify the content 310 and the bandwidth parameter 320 for each of a plurality of transmission modes 330 of the content. For example, a given content can be received from the internet in a 480 p format that consumes 35 megabytes (MB) of bandwidth, in 720 p format that consumes 109 MB, and in 1080 p format that consumes 167 MB. The graphical user interface enables a user to select a given format, and therefore bandwidth requirement, of the content. The bandwidth usage data may be gathered by the lower layer networking drivers. The data can be periodically collected by the bandwidth reporting application and stored in the memory 130 of the TV 110. In an alternative implementation, various networked applications could maintain a count of how much bandwidth each has used so far. Each application would share this information when queried by the bandwidth reporting application.

Referring again to FIG. 2, a selection of a given instance of a given content is received on the network-enabled TV in response to the displayed bandwidth information, at 230. In one implementation, the bandwidth reporting application receives the selection of a format of the content from a user via the graphical user interface output on the display. At 240, the network enabled TV sends a request for the selected instance of the given content on the given network. At 250, the network enabled TV receives the requested instance of the given content on the given network. At 260, the networked enabled TV displays the given instance of the given content.

In an optional process, the networked-enabled TV may determine if the network has a bandwidth restriction, at 270. In one implementation, the bandwidth reporting application determines any bandwidth restrictions such as bandwidth limits, bandwidth rate charges, bandwidth overage charges, and the like from configuration information. If the content will be received on a network having a bandwidth restriction, the processes of 210-260 are performed. If the content will be received on a network not having a bandwidth restriction (e.g., digital living network alliance (DLNA) content streamed over a local area network), the processes of 210 and 220 may be skipped, and the content may be selected and received without regard to the bandwidth usage.

In another optional process, the network-enabled TV may automatically or manually control the bandwidth used by each application currently running on the TV. For example, the currently active application may be given more bandwidth to ensure the smooth operation of that application, since the user is viewing the output on the monitor of the current active application. Other application that are not being rendered on the monitor, or are running in the background, such as network enabled widgets (e.g., a countdown to an event widget) on the TV may be allocated less bandwidth for its operation as the user is not focusing on it and hence are given less priority.

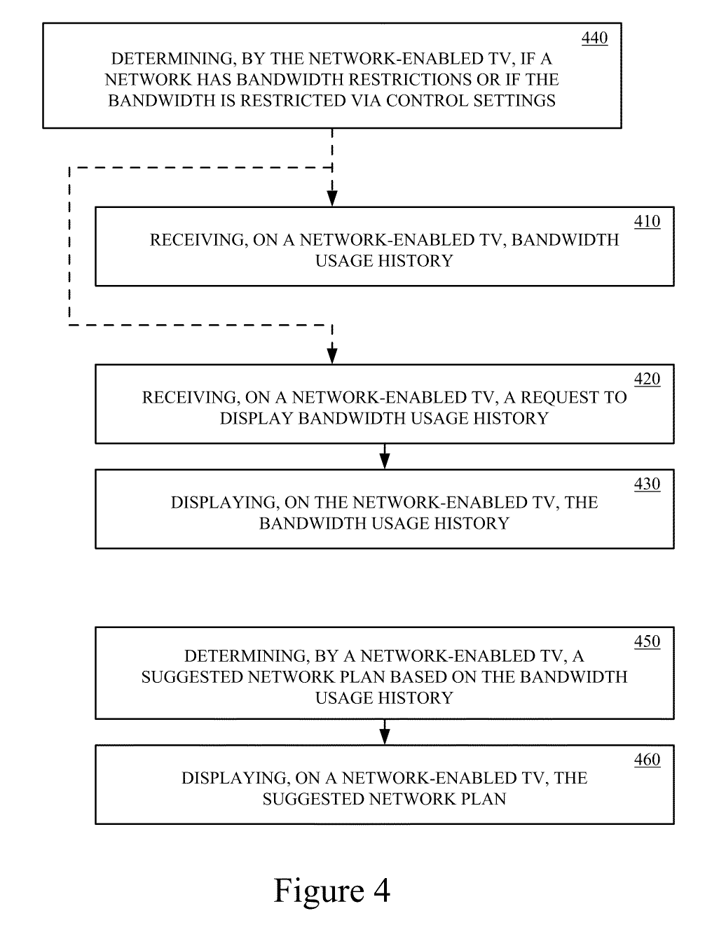

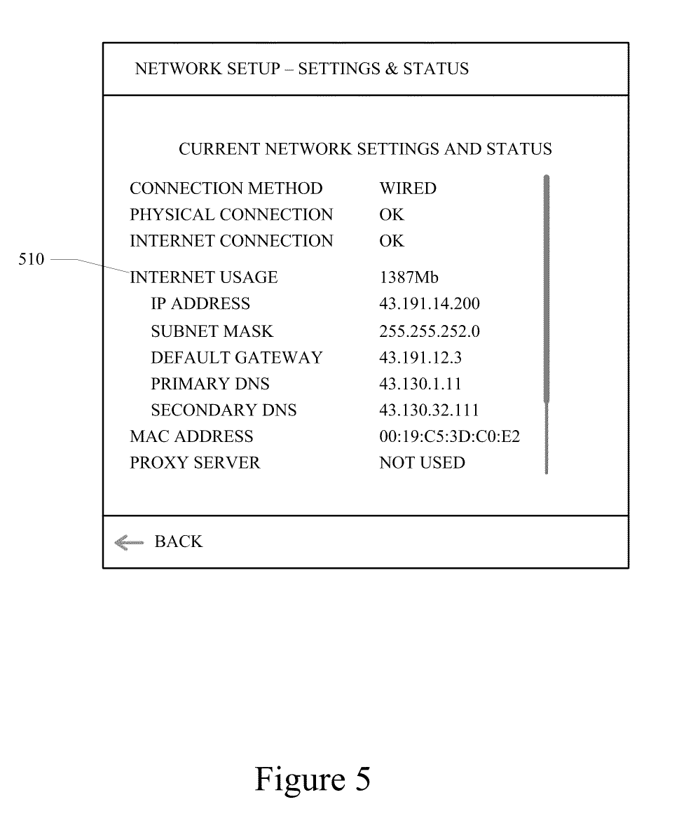

Referring now to FIG. 4, a method of reporting bandwidth usage, in accordance with another embodiment of the present technology, is shown. At 410, bandwidth usage history is received on a network-enabled TV. In one implementation, the bandwidth reporting application receives information from one or more applications about the bandwidth usage for a given period of time on one or more networks by the applications. In another implementation, the bandwidth reporting application receives data from one or more network interface drivers concerning the network usage for a given period of time. At 420, a request to display bandwidth usage history is received on the network-enabled TV. For example, the bandwidth reporting application may receive a request to display a control panel that includes bandwidth usage parameters for a given period of time. It is appreciated that the bandwidth monitoring process at 410 may occur independently of the other processes of the method (as illustrated in FIG. 4), or may occur in response to receiving a request for the bandwidth usage at 420. At 430, the bandwidth usage history is displayed on the network-enabled TV. In one implementation, the bandwidth reporting application generates a graphical user interface including bandwidth usage history for a given period of time. Referring now to FIG. 5, an exemplary graphical user interface, in accordance with another embodiment of the present technology, is shown. The graphical user interface may be a control panel that reports one or more parameters including the bandwidth usage parameter 510 for a given period of time. The user may be presented with an option to reset the value when a new billing/monitoring cycle is about to begin.

In an optional process, the networked-enabled TV may determine if a network has bandwidth restrictions, at 440. The networked-enabled TV may set a corresponding flag if a network has a bandwidth restriction. Alternatively, the user may be able to set the bandwidth restriction flag via an option in the control setting for the TV. The process at 410 may be selectively performed for each network having bandwidth restrictions. Similarly, if the network has a bandwidth restriction, the processes of 420 and 430 may be performed. If the network does not have a bandwidth restriction (e.g., local DLNA stream), the processes of 420 and 430 may be skipped for the given network.

In another optional process, the network-enabled TV may determine a network plan (e.g., internet usage pricing plan) based on the bandwidth usage history, at 450. In one implementation, the bandwidth reporting application in the TV may be able to determine a suggested internet plan that is best suited for the users' viewing habits based on the bandwidth usage history. At 460, the suggested network plan may be displayed on the network-enabled TV.

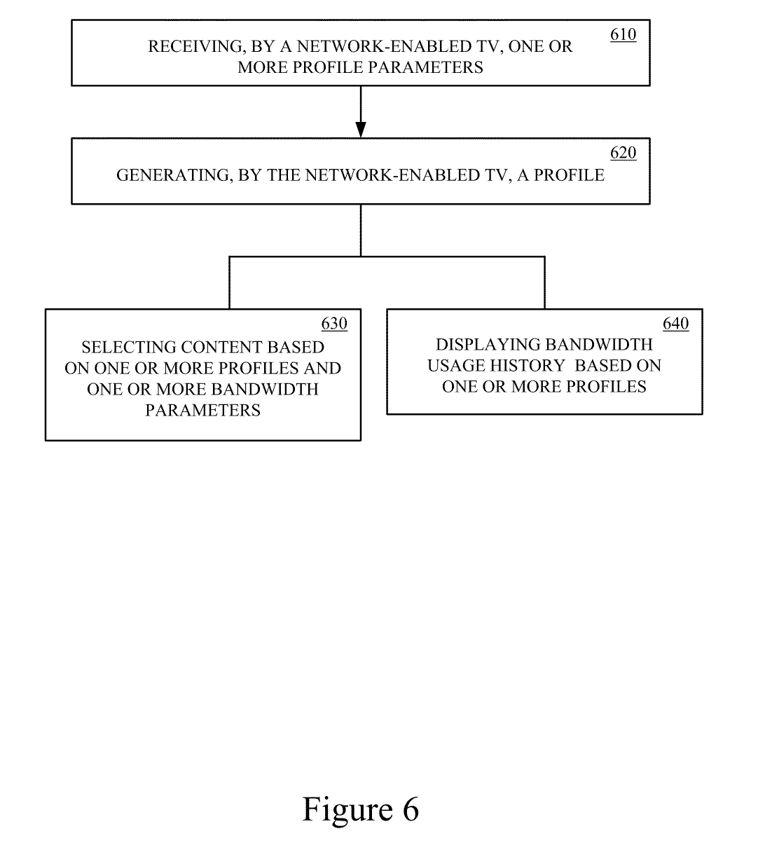

Referring now to FIG. 6, a method of creating a user profile for bandwidth based selection of content and/or bandwidth usage reporting, in accordance with another embodiment of the present technology, is shown. At 610, one or more profile parameters are received by a network-enabled TV. In one implementation, the bandwidth reporting application receives one or more profile parameters from a user and/or other sources. At 620, a profile for displaying bandwidth information and/or selecting content based on the one or more profile parameters is generated by the network enabled TV. In one implementation, the bandwidth reporting application generates a profile based on the one or more received profile parameters and stores it in a corresponding data structure in the memory 130. In addition, the data structure may include one or more pre-configured (e.g., default) profiles. At 630, the method of bandwidth based selection of content described above with reference to FIG. 2 may be performed based on one or more profiles. Likewise, the method of reporting bandwidth usage described above with reference to FIG. 4 may be performed based on one or more profiles, at 640.

Embodiments of the present technology advantageously enable TVs to report the amount of bandwidth used. In addition, embodiments can advantageously provide information on the total bandwidth requirements for a given content, such as a video stream downloaded from the internet. Embodiments advantageously enable a user to more effectively control their bandwidth usage when receiving content on a network-enabled TV. For example, a user may choose to play the same content stream but at a different quality to suit their bandwidth/playback preference, to conserve bandwidth, to avoid bandwidth overage penalties and/or the like.

The foregoing descriptions of specific embodiments of the present technology have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

What is claimed is:

1. A method comprising:
receiving, by a network-enabled television from a given network, bandwidth information regarding content;
displaying, on the network-enabled television, the bandwidth information for receiving one or more instances of the content;
receiving, on the network-enabled television, a selection of a given instance of the content in response to the displayed bandwidth information;
sending, by the network-enabled television on the given network, a request for the given instance of the content in response to the received selection;
receiving, by the network-enabled television from the given network, the requested given instance of the content; and
displaying, on the network-enabled television, the received given instance of the content.

2. The method according to claim 1, further comprising:
determining, by the network-enabled television, if the given network has a bandwidth restriction;
receiving the bandwidth information regarding the content if the given network has a bandwidth restriction; and
displaying the bandwidth information if the given network has a bandwidth restriction.

3. The method according to claim 1, wherein displaying the bandwidth information comprises:
generating a graphical user interface including a content identifier and a bandwidth parameter for each instance of the content; and
displaying the graphical user interface.

4. The method according to claim 1, further comprising:
receiving, by the network-enabled television, one or more profile parameters;
generating, by the network-enabled television, a profile; and
displaying the bandwidth information for receiving one or more instances of the content based on one or more profiles.

5. The method according to claim 1, further comprising receiving, on the network-enabled television, bandwidth usage history.

6. The method according to claim 5, further comprising:
receiving, on the network-enabled television, a request to display bandwidth usage history; and
displaying, on the network-enabled television, the bandwidth usage history.

7. The method according to claim 6, wherein displaying the bandwidth usage history comprises:
generating a graphical user interface including bandwidth usage parameter; and
displaying the graphical user interface.

8. The method according to claim 6, further comprising:
determining, by the network-enabled television, if the given network has a bandwidth restriction;
receiving the bandwidth usage history if the given network has a bandwidth restriction; and
displaying the bandwidth usage history if the given network has a bandwidth restriction.

9. The method according to claim 5, further comprising:
determining, by the network-enabled television, a suggested network plan based on the bandwidth usage history; and
displaying, on the network-enabled television, the suggested network plan.

10. One or more computing device readable media containing a plurality of computing device-executable instructions which when executed cause a system to implement a method comprising:
receiving, by a network-enabled television, information indicating an amount of bandwidth for receiving one or more instances of one or more content on one or more networks;
displaying, on the network-enabled television, the bandwidth information for receiving the one or more instances of the one or more content;
receiving, on the network-enabled television, a selection of a given instance of a given content in response to the displayed bandwidth information;
sending, by the network-enabled television on a given network, a request for the given instance of the given content in response to the received selection;
receiving, by the network-enabled television from the given network, the requested given instance of the given content; and
displaying, on the network-enabled television, the received given instance of the given content.

11. The one or more computing device readable media containing the plurality of computing device-executable instructions which when executed cause the system to implement the method of claim 10, further comprising:
determining, by the network-enabled television, if the given network has a bandwidth restriction;
receiving the information indicating the amount of bandwidth for receiving the content if the given network has a bandwidth restriction; and
displaying the bandwidth information if the given network has a bandwidth restriction.

12. The one or more computing device readable media containing the plurality of computing device-executable instructions which when executed cause the system to implement the method of claim 11, further comprising:
receiving, by the network-enabled television, one or more profile parameters;
generating, by the network-enabled television, a profile; and
displaying the bandwidth information for receiving one or more instances of the content based on one or more profiles.

13. The one or more computing device readable media containing the plurality of computing device-executable instructions which when executed cause the system to implement the method of claim 12, further comprising receiving, on the network-enabled television, bandwidth usage history.

14. The one or more computing device readable media containing the plurality of computing device-executable instructions which when executed cause the system to implement the method of claim 13, further comprising:
receiving, on the network-enabled television, a request to display bandwidth usage history; and
displaying, on the network-enabled television, the bandwidth usage history.

15. The one or more computing device readable media containing the plurality of computing device-executable instructions which when executed cause the system to implement the method of claim 14, further comprising:
determining, by the network-enabled television, if the given network has a bandwidth restriction;
receiving the bandwidth usage history if the given network has a bandwidth restriction; and
displaying the bandwidth usage history if the given network has a bandwidth restriction.

16. One or more computing device readable media containing a plurality of computing device-executable instructions which when executed cause a system to implement a method comprising:
receiving, on the network-enabled television, bandwidth usage history for one or more networks;
receiving, on the network-enabled television, a request to display bandwidth usage history; and
displaying, on the network-enabled television, the bandwidth usage history for the one or more networks.

17. The one or more computing device readable media containing the plurality of computing device-executable instructions which when executed cause the system to implement the method of claim 16, further comprising:
determining, by the network-enabled television, if each of the one or more networks have a bandwidth restriction;
receiving, on the network-enabled television, the bandwidth usage history if the given network has the bandwidth restriction; and
displaying, on the network-enabled television, the bandwidth usage history for each of the given networks that have the bandwidth restriction.

18. The one or more computing device readable media containing the plurality of computing device-executable instructions which when executed cause the system to implement the method of claim 17, further comprising:
receiving, by the network-enabled television, one or more profile parameters;
generating, by the network-enabled television, a profile; and
displaying the bandwidth usage history for each of the given networks that have the bandwidth restriction based on one or more profiles.

19. The one or more computing device readable media containing the plurality of computing device-executable instructions which when executed cause the system to implement the method of claim 17, wherein the bandwidth usage history is received from each of one or more applications used to download content.

20. The one or more computing device readable media containing the plurality of computing device-executable instructions which when executed cause the system to implement the method of claim 17, wherein the bandwidth usage history is received from one or more network interface drivers.
